(19) United States
(12) Patent Application Publication
(10) Pub. No.: US 2012/0180747 A1
(43) Pub. Date: Jul. 19, 2012

(54) THERMAL SPRAY COATING WITH A DISPERSION OF SOLID LUBRICANT PARTICLES

(76) Inventors: David Domanchuk, Grand Haven, MI (US); Thomas Stong, Kent City, MI (US); Thomas J. Smith, Muskegon, MI (US)

(21) Appl. No.: 13/351,337

(22) Filed: Jan. 17, 2012

Related U.S. Application Data
(60) Provisional application No. 61/433,781, filed on Jan. 18, 2011.

(51) Int. Cl. F02F 3/00; C23C 4/18; F16C 7/00; F16J 9/26; F16C 9/00; F02F 1/00; C23C 4/04; C10M 125/04

(52) U.S. Cl. 123/193.6; 427/446; 508/150; 508/154; 277/442; 384/416; 123/193.2; 74/579 E; 74/567

(57) ABSTRACT

Thermal spray coatings are described herein. The coatings include at least one base material having a thickness. Within at least a portion of the thickness is a dispersion of solid lubricant particles. The thermal spray coatings may be applied to at least a portion of a component that has a mating surface with another component. The mating surface may cause the thermal spray coating to wear down and become thinner. As the coating becomes thinner, particles of solid lubricant entrapped deeper within in the base material become exposed and impart friction reducing properties to the component.

### CROSS-REFERENCE TO RELATED APPLICATIONS

This application claims priority to U.S. Provisional Patent Application No. 61/433,781, filed Jan. 18, 2011, which is incorporated by reference in its entirety.

### FIELD

The present disclosure relates to thermal spray coatings comprising solid lubricant particles dispersed therein.

### BACKGROUND

Many mechanical systems, including but not limited to spark-ignition and diesel engines, include components that have reciprocating, sliding, or rotational motion between mating surfaces. Such components may include, by way of non-limiting example, piston rings, bearings, liners, pistons, connecting rods and camshafts.

Continued use of these systems causes wear on the mating surfaces and may impact the efficiency and/or overall performance of the mechanical system. As a result, manufacturers of such systems seek to make or purchase from suppliers components that have a low coefficient of friction to minimize wear, improve efficiency and/or to have a higher seizure resistance.

Thermal spray coatings have been applied to components to increase the life the component by, among other things, reducing friction between mating surfaces. However, conventional thermal spray coatings can be improved by further lowering the coefficient of friction. It has been attempted to apply lubricant films to components. However, many such lubricant films do not last long in high performance applications. This may be at least in part due to the nature and strength of the bond between the lubricant composition and the surface of the component. This may also be due at least in part to the fact that once lubricant films wear off, the lubricant is essentially gone from the system. That is, there is no additional lubricant in the thermal spray coating as the mating surfaces continue to contact and the thermal spray coating continues to wear down and become thinner.

### BRIEF DESCRIPTION OF THE DRAWINGS

While the claims are not limited to the illustrated embodiments, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows

FIG. 1 depicts an exemplary thermal spray coating on at least a portion of a surface of a component.

FIG. 2 depicts an exemplary thermal spray coating, partially worn away, on at least a portion of a surface of a component.

FIG. 3 depicts an exemplary method for applying a thermal spray coating with a dispersion of solid lubricant particles.

FIG. 4 depicts another exemplary method for applying a thermal spray coating with a dispersion of solid lubricant particles.

### DETAILED DESCRIPTION

While the claims are not limited to the illustrated examples, an appreciation of various aspects is best gained through a discussion of various examples thereof. Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain an innovative aspect of an example. Further, the descriptions set forth herein are not intended to be exhaustive or otherwise limit or restrict the claims to the precise forms and configurations shown in the drawings and disclosed in the following detailed description.

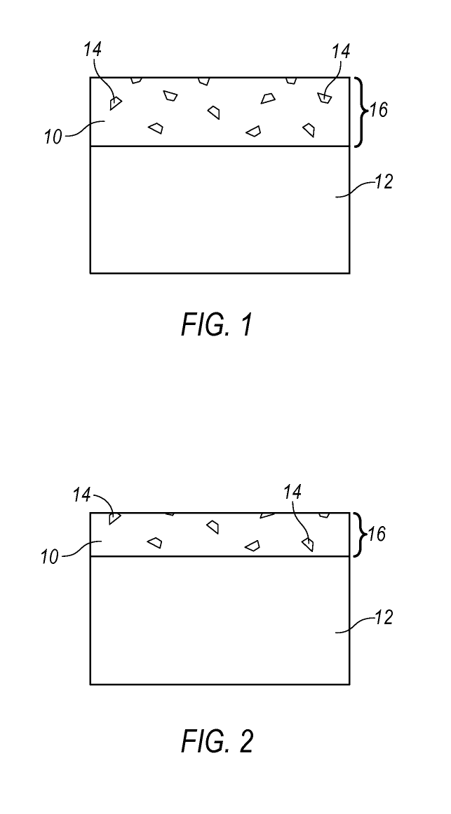

Referring to FIG. 1, a component 12 has a surface, at least a portion of which has a thermal spray coating 16 thereon. The thermal spray coating 16 includes a dispersion of solid lubricant particles 14 within at least a portion of a thickness of at least one base material 10. Referring to FIGS. 1 and 2, an example is shown where an originally-applied thermal spray coating 16 in FIG. 1 wears away and becomes thinner through usage, the result of which is shown in FIG. 2. In FIG. 2, different solid lubricant particles 14 are exposed than were exposed in FIG. 1. Some of the solid lubricant particles 14 exposed in FIG. 1 have worn away and are absent in FIG. 2. The solid lubricant particles 14 that are entrapped deeper into the thickness of the base material 10 become exposed after wear on the thermal spray coating 16, thereby providing a source of lubricant in the thermal spray coating 16 for use with the mating surfaces in the mechanical system as the thermal spray coating 16 wears away. Thus, the thermal spray coating 16 disclosed herein may provide one or more of the benefits of reducing friction during the life of the thermal spray coating 16, increasing scuff resistance and extending wear life of the component 12.

Component 12 may be any of a number of components in a mechanical system, including but not limited to components used in mechanical systems such as spark-ignition engines and diesel engines. Exemplary components include but are not limited to piston rings, valves, bearings, liners, pistons, connecting rods and camshafts.

Many materials may be suitable as base materials 10 for thermal spray coating 16. For example, base materials 10 may comprise molybdenum-based, nickel-based, chrome-based, tungsten-based, iron-based, cobalt-based, and/or copper-based materials. Base materials 10 may also compromise a carbide, oxide or nitride of one or more metals. Base materials 10 may include alloys such as, by way of non-limiting example, CrC/NiCr, WC/Co(Cr), Mo/Ni Alloy, and CrN/Ni. Other ceramic and metallic containing materials may also be suitable as base materials 10.

The base material 10 may have a generally uniform thickness. Different thicknesses may be more suited to different applications, depending upon the particular component 12 to be coated with the thermal spray coating 16. For example, if component 12 is a piston ring, the thickness of the base material 10 (and the thermal spray coating 16) may be up to 125 microns, and may be even thicker if desired. In another example where component 12 is a piston ring, the thickness may be 25-75 microns or less. The thickness of thermal spray coating 16, of course, becomes reduced through use of component 12 where thermal spray coating 16 mates with a surface of another component in the mechanical system.

Many solid lubricant particles 14 may be suitable for dispersion in at least a portion of the thickness of the base material 10 to form the thermal spray coating 16. For example, solid lubricant particles 14 may comprise one or more of tin, bismuth, lead, tungsten disulfide, graphite, molybdenum disulfide, polytetrafluoroethylene, talc, boron nitride, calcium fluoride, barium fluoride, and cerium fluoride. The solid lubricant particles 14 may have a static coefficient of friction and a dynamic coefficient of friction sufficient to lower the coefficients of friction of the coated component 12 relative to a coated component 12 without solid lubricant particles 14 dispersed therein. An exemplary tungsten disulfide powder has a dynamic coefficient of friction of about 0.03 and a static coefficient of friction of about 0.07.

The solid lubricant may be in powder form. The solid lubricant particles 14 may be in many shapes, including but not limited to irregular shapes and substantially spherical shapes. Different average particle sizes for powders may be used, depending upon the application for which the component 12. For example, larger average particle sizes may be well suited for examples where component 12 is a rough cut surface, and smaller average particle sizes may be well suited for examples where component 12 is highly finished. Average particle size should be suitable for adequate dispersion in the base material 10, and should not be so small as to result in premature oxidation. Average particle size may depend upon the chemical composition of the solid lubricant particles 14. In an example of a powder tungsten disulfide, average particle size may include particles having a diameter of between about 0.5 and about 50 microns, including tungsten disulfide particles having an average diameter of about 1 micron, about 5 microns, about 10 microns, or about 25 microns, among other diameters. Such particle sizes may be determined using the Fisher Sub-Sieve Sizer (FSSS), as set forth in ASTM B 330 (Standard Test Method for Fisher Number of Metal Powders and Related Compounds).

Many weight percentages of solid lubricant particles 14 with respect to the weight of overall thermal spray coating 16 may be suitable, depending upon the application of component 12 and the associated balance between low friction properties and structural strength and integrity at the surface. In an exemplary piston ring, the weight percentage of the solid lubricant particles 14 in the thermal spray coating 16 may be less than about 50% by weight, less than about 40% by weight, less than about 20% by weight, less than about 10% by weight, or less than about 5% by weight.

Optional materials may be included in the thermal spray coating 16 along with base material 10 and solid lubricant particles 14. Optional materials may include, by way of non-limiting example, organic binder materials for the solid lubricant particles 14, surfactants and other materials.

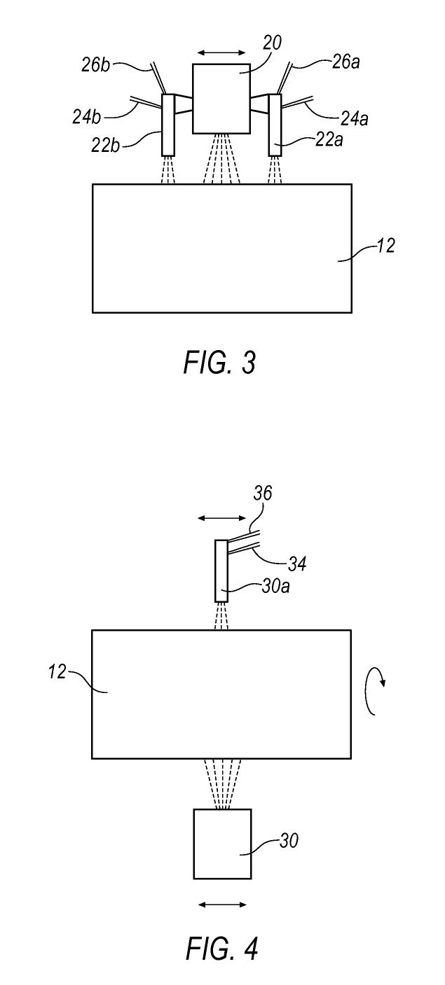

Referring to FIGS. 3 and 4, exemplary methods of applying thermal spray coating 16 with a base material 10 and a dispersion of solid lubricant particles 14 to a component 12 are described. In FIG. 3, a thermal spray gun 20 has at least one nozzle dispersing a thermal spray coating. In the example of FIG. 3, two additional air pressurized nozzles 22A and 22B are mounted, directly or indirectly (such as, for example via a spray gun manipulator), to the spray gun 20. Nozzles 22A and 22B may be positioned in such a manner that the nozzles and their output does not interfere with the thermal spray gun plume. In another method, nozzles 22A and 22B may be positioned in such a manner that the nozzles and their output does interfere with the thermal spray gun plume. Solid lubricant particles 14 are fed through lines 24A and 24B, and forced through the nozzles 22A and 22B by pressurized air provided via lines 26A and 26B. It is contemplated that fewer or more nozzles for solid lubricant particles 14 may be used with the systems disclosed herein.

When the thermal spray gun 20 is ready to start coating a component 12, the gun 20 is fired and powder (of one or more base materials) are injected into the thermal spray gun plume to be applied as a coating 16 to at least a portion of a surface of component 12. As the gun manipulator begins to move across the component 12, the air pressurized nozzles 22A and 22B are activated to start the flow of dry lubricant powder. While the spray gun 20 makes several passes across the component 12, the solid lubricant particles 14 are applied and become entrapped and dispersed throughout at least a portion of the thickness of base material 10 of thermal spray coating 16. The application of the solid lubricant particles 14 may be performed substantially contemporaneously with the application of the particles making up the one or more base materials 10 for the coating 16. In an exemplary applied thermal spray coating 16, the dispersion is a fine dispersion of tungsten disulfide particles throughout at least a portion of the thickness of the base material 10.

Referring to FIG. 4, another exemplary application method is depicted. In this example, component 12 is rotated about an axis. A spray gun 30 applies the one or more base materials 10 for the thermal spray coating 16 through at least one nozzle. In this example, a separately controlled spray gun 30A (possibly through a separate gun manipulator) applies the solid lubricant particles 14, fed through line 34 and pressurized by air fed through line 36, through at least one nozzle. The application of the solid lubricant particles 14 to component 12 may be substantially contemporaneous with the application of the particles making up the base material 10 for the coating 16 to component 12. The particles 14 become dispersed in and entrapped in at least a portion of the thickness of the base material 10 of the coating 16. In an exemplary applied thermal spray coating 16, the dispersion is a fine dispersion of tungsten disulfide particles throughout at least a portion of the thickness of the base material 10.

Without being bound by theory, the entrapped solid lubricant particles 14 may achieve better lubrication and component life results for components 12 than traditionally applied layers of solid lubricant films because the solid lubricant particles 14 are dispersed throughout some or all of the thickness of the base material 10 of the thermal spray coating 16 rather than existing as a separate thin film layer. For example, traditional tungsten disulfide film layers may have a thickness of about 0.5 microns. In such thin layers, where the compounds that form the layers may be bonded to a substrate via relatively weak molecular bonds, the thin layers of lubricant wear off relatively quickly and the lubricant may become fully removed from the remaining thermal spray coating 16 as the coating 16 becomes thinner through wear. By contrast, in the thermal spray coatings 16 disclosed herein, entrapment of solid lubricant particles 14 may provide physical reinforcement of solid lubricant particles 14 by base materials 10 to support otherwise relatively weak molecular bonds. Moreover, physical entrapment of solid lubricant particles 14 throughout at least a portion of the thickness of the base materials 10 may provide a longevity of friction reducing compounds in the thermal spray coating 16 as the thermal spray coating 16 becomes worn away and thinner through use of component 12. That is, the present approach involves applying solid lubricant particles 14 within a thermal spray coating 16 that encapsulates or traps the solid lubricant particles 14 in at least a portion of the thickness of the base material 10, so as the coating 16 becomes thinner, new solid lubricant particles 14 that were entrapped deeper in to the coating 16 are being exposed at the surface of coated component 12 to assist in maintaining a low coefficient of friction between mating surfaces for the component 12.

Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A thermal spray coating, comprising:
at least one base material having solid lubricant particles entrapped within a thickness of the base material such that as the thermal spray coating becomes thinner, entrapped solid lubricant particles become exposed.

2. The thermal spray coating of claim 1 wherein the base material is at least one of ceramic and metallic.

3. The thermal spray coating of claim 1 wherein the base material is selected from the group consisting of molybdenum-based, nickel-based, chrome-based, tungsten-based, iron-based, cobalt-based and copper-based materials.

4. The thermal spray coating of claim 1 wherein the base material is selected from the group consisting of carbide, oxide and nitride materials.

5. The thermal spray coating of claim 1 wherein the solid lubricant particles comprise at least one of tin, bismuth, lead, tungsten disulfide, graphite, molybdenum disulfide, polytetrafluoroethylene, talc, boron nitride, calcium fluoride, barium fluoride and cerium fluoride.

6. The thermal spray coating of claim 1 wherein the solid lubricant particles have an average particle size sufficient to form a dispersion in at least a portion of the thickness of the base material.

7. The thermal spray coating of claim 1 wherein the solid lubricant particles have an average particle size of less than about 50 microns in diameter.

8. The thermal spray coating of claim 1 wherein the solid lubricant particles are present in the coating in an amount sufficient to impart friction reducing properties on a coated component.

9. The thermal spray coating of claim 1 wherein the solid lubricant particles are present in the coating in an amount of less than about 50% by weight of the coating.

10. A method of imparting friction-reducing properties to a component, comprising:
thermally spraying at least one base material on the component; and
generating a dispersion of particles of at least one solid lubricant in at least a portion of the thickness of the base material, thereby creating a coating having entrapped solid lubricant particles therein.

11. The method of claim 10, wherein generating the dispersion comprises spraying the solid lubricant particles through at least one nozzle while the base material is being sprayed through at least one different nozzle.

12. The method of claim 10 further comprising controlling the thermally spraying at least one base material and the generating the dispersion by using a shared spray gun manipulator.

13. The method of claim 10 further comprising controlling the thermally spraying at least one base material and the generating the dispersion by using independently controlled spray gun manipulators.

14. A component that is at least partially coated by the method of claim 10.

15. A coated component comprising:
a component having a surface of which at least a portion has a thermal spray coating thereon, the coating including a base material having a thickness including a dispersion of solid lubricant particles therein.

16. The component of claim 15 wherein the component is a component of a diesel or spark-ignition engine.

17. The component of claim 16 wherein the component is selected from the group consisting of a piston ring, bearing, liner, piston, connecting rod and camshaft.

18. The component of claim 15 wherein the base material is selected from the group consisting of molybdenum-based, nickel-based, chrome-based, tungsten-based, iron-based, cobalt-based and copper-based materials.

19. The component of claim 15 wherein the base material is selected from the group consisting of carbide, oxide and nitride materials.

20. The component of claim 15 wherein the solid lubricant particles comprise at least one of tin, bismuth, lead, tungsten disulfide, graphite, molybdenum disulfide, polytetrafluoroethylene, talc, boron nitride, calcium fluoride, barium fluoride and cerium fluoride.

21. (canceled)
